(19) United States
(12) Patent Application Publication
(10) Pub. No.: US 2009/0071586 A1
(43) Pub. Date: Mar. 19, 2009

(54) Rubber Composition And Pneumatic Tire

(75) Inventor: Norihiko Nakamura, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/208,427

(22) Filed: Sep. 11, 2008

(30) Foreign Application Priority Data
Sep. 18, 2007 (JP) 2007-241189

(51) Int. Cl. B60C 1/00; C08L 65/00; C08K 5/01

(52) U.S. Cl. 152/525; 524/526

(57) ABSTRACT

A rubber composition is provided that is capable of improving both the road/tire noise and the rolling resistance simultaneously, and is suitable for a side wall. The rubber composition contains a rubber component containing from 20 to 80 parts by weight of at least one of natural rubber and isoprene rubber and from 80 to 20 parts by weight of butadiene rubber, a reinforcing agent, a plasticizer, an additive and a crosslinking agent, and having a dynamic elastic modulus (E′) and a loss factor (tan δ), which are measured according to JIS K6394 at an initial strain of 5%, a dynamic strain of 5%, a frequency of 10 Hz and a temperature of 35° C., satisfying relationships, E′≧4 and tan δ/E′≦0.03. The butadiene rubber preferably contains at least one selected from the group consisting of (A) a coordination polymer of butadiene with a transition metal compound or a metallocene complex of a transition metal compound as a catalyst, (B) an anionic polymer of butadiene with a lithium compound as a catalyst, and (C) butadiene rubber containing syndiotactic 1,2-polybutadiene crystals.

### BACKGROUND OF THE INVENTION

1. Field of the Invention

The present invention relates to a rubber composition and a pneumatic tire, and more specifically, it relates to a rubber composition capable of reducing road/tire noise and rolling resistance of a tire without deterioration in basic capabilities of a side wall including durability and appearance.

2. Related Art

According to social demand in recent years, a pneumatic tire is strongly demanded to have decreased rolling resistance for reducing fuel consumption. Separately, according to spread of luxury cars, there is a demand of reducing in-car noise including road/tire noise.

Rubber having a relatively low rigidity has been conventionally used in a side wall of a pneumatic tire. For example, it has been disclosed that highly damped rubber having a large tan δ is disposed in a side wall as a measure for reducing road/tire noise (for example, in JP-A-11-151917), but according to the measure, highly damped rubber increases energy loss to deteriorate the rolling resistance of the tire, and thus it has been difficult to decrease both road/tire noise and rolling resistance simultaneously.

### BRIEF SUMMARY OF THE INVENTION

Under the circumstances, an object of the invention is to provide a rubber composition suitable for a side wall of a tire, the rubber composition being capable of reducing both road/tire noise and rolling resistance of a tire simultaneously without deterioration in basic capabilities of a side wall including durability and appearance, and to provide a pneumatic tire using the rubber composition.

As a result of earnest investigations for solving the problems by the inventors, it has been found that both road/tire noise and rolling resistance can be reduced by using natural rubber and butadiene rubber as a rubber component for ensuring durability of a side wall, and simultaneously setting viscoelastic characteristics of rubber for a side wall to prescribed ranges.

The invention relates to, as one aspect, a rubber composition containing a rubber component containing from 20 to 80 parts by weight of at least one of natural rubber and polyisoprene rubber and from 80 to 20 parts by weight of butadiene rubber, a reinforcing agent, a plasticizer, an additive and a crosslinking agent, and having a dynamic elastic modulus (E′) and a loss factor (tan δ), which are measured according to JIS K6394 at an initial strain of 5%, a dynamic strain of 5%, a frequency of 10 Hz and a temperature of 35° C., satisfying relationships, E′≧4 and tan δ/E′≦0.03.

It is preferred in the invention that the butadiene rubber contains at least one selected from the group consisting of (A) a coordination polymer of butadiene with a transition metal compound or a metallocene complex of a transition metal compound as a catalyst, (B) an anionic polymer of butadiene with a lithium compound as a catalyst, and (C) butadiene rubber containing syndiotactic 1,2-polybutadiene crystals.

The anionic polymer of butadiene (B) may be one having polymer ends modified with a modifying agent.

The invention also relates to, as another aspect, a pneumatic tire containing the rubber composition in a side wall.

According to the rubber composition of the invention, the rubber composition has viscoelastic characteristics satisfying E′≧4 and tan δ/E′≦0.03 to optimize the viscoelasticity and the damping property, and by using the rubber composition in a side wall of a pneumatic tire, the road/tire noise and the rolling resistance of the tire can be simultaneously reduced. In particular, the rubber composition is effective for reducing road/tire noise having a high frequency of from 250 to 400 Hz.

### DETAILED DESCRIPTION OF THE INVENTION

Embodiments of the invention will be described.

The rubber composition of the invention contains a rubber component containing from 20 to 80 parts by weight of at least one of natural rubber (NR) and polyisoprene rubber (IR) and from 80 to 20 parts by weight of butadiene rubber (BR), and may additionally contain diene rubber, such as styrene-butadiene rubber (SBR), chloroprene rubber (CR) and nitrile rubber (NBR).

Examples of the NR include natural rubber that is ordinarily used in tires, such as ribbed smoked sheet (RSS #1 to #3) and technically specified rubber (e.g., SMR and TTR).

Examples of BR include (A) a coordination polymer of butadiene with a transition metal compound or a metallocene complex of a transition metal compound as a catalyst, (B) an anionic polymer of butadiene with a lithium compound as a catalyst, and (C) butadiene rubber containing syndiotactic 1,2-polybutadiene crystals. These may be used solely or as a mixture of two or more of them at an arbitrary ratio.

In the BR (A), a transition metal compound is used as a catalyst. The transition metal compound is not particularly limited as far as the compound contains a transition metal and is soluble in a polymerization solvent, and in general, a salt of a transition metal may be used.

Examples of the transition metal include titanium, chromium, manganese, iron, cobalt, nickel, copper, yttrium, lanthanum and neodymium, and preferred examples thereof include cobalt, nickel and neodymium. Preferred examples of the transition metal compound include an organic cobalt salt, such as cobalt acetate, cobalt propionate, cobalt butyrate, cobalt hexanoate, cobalt octenoate, cobalt laurate, cobalt stearate, cobalt isostearate, cobalt naphthenoate and cobalt benzoate, an organic nickel salt, such as nickel hexanoate, nickel octenoate, nickel stearate, nickel naphthenoate and nickel benzoate, an organic iron salt, such as iron hexanoate, iron octenoate, iron stearate, acetylacetonato iron, iron naphthenoate and iron benzoate, a cobalt β-diketone complex salt, such as acetylacetonato cobalt, a nickel β-diketone complex salt, such as acetylacetonato nickel, a cobalt pyridine complex salt, such as cobalt chloride pyridine complex salt, a cobalt phosphine complex salt, such as cobalt chloride triphenylphosphine complex salt, a cobalt oxime complex salt, such as cobalt dimethylglyoxime complex salt, and a nickel oxime complex salt, such as nickel dimethylglyoxime complex salt.

Preferred examples among these include cobalt acetate, cobalt propionate, cobalt butyrate, cobalt hexanoate, cobalt octenoate, cobalt laurate, cobalt stearate, cobalt isostearate, acetylacetonato cobalt, cobalt naphthenoate, cobalt benzoate, nickel hexanoate, nickel octenoate, nickel stearate, nickel naphthenoate and nickel benzoate, and particularly preferred examples thereof include cobalt hexanoate, cobalt octenoate, cobalt stearate, cobalt naphthenoate and cobalt benzoate.

Examples of the metallocene complex of a transition metal compound include a known metallocene complex of a transition metal compound of Groups 4 to 8 in Periodic Table. Specific examples thereof include a metallocene complex of a transition metal of Group 4 in Periodic Table, such as titanium and zirconium, a metallocene complex of a transition metal of Group 5 in Periodic Table, such as vanadium, niobium and tantalum, a metallocene complex of a transition metal of Group 6 in Periodic Table, such as chromium, and a metallocene complex of a transition metal of Group 8 in Periodic Table, such as cobalt and nickel.

The BR (A) may be produced by a known polymerization method, such as a method disclosed in JP-A-2003-292515.

The lithium compound used as a polymerization catalyst for the BR (B) is not particularly limited and may be an organolithium compound ordinarily used. Examples thereof include an alkyllithium, such as methyllithium, ethyllithium, propyllithium, n-butyllithium, sec-butyllithium, tert-butyllithium, n-hexyllithium and n-octyllithium, an aryllithium, such as phenyllithium, tolyllithium and lithium naphthylide, an alkenyllithium, such as vinyllithium and propenyllithium, and an alkylene dilithium, such as tetramethylene dilithium, pentamethylene dilithium, hexamethylene dilithium and decamethylene dilithium.

The BR (B) may be produced by a polymerization method having been known in the art.

The BR (B) may have polymer ends that are modified with a modifying agent such as a tin compound and the like. In the BR (B), an amino group, an epoxy group, a hydroxyl group, a cyano group, a carboxyl group, a halogen atom, an alkoxy group and the like are introduced into the polymer ends by modification. The modification degree may be 20% or more, and preferably 40% or more.

Examples of the tin compound include a halogenated tin compound, such as tin tetrachloride, methyltrichlorotin, dibutyldichlorotin and tributylchlorotin, an allyltin compound, such as tetraallyltin, diethyldiallyltin and tetra(2-octenyl)tin, tetraphenyltin and tetrabenzyltin, and a halogenated tin compound is particularly preferred.

In the end-modified BR, the end moieties having been modified exert mutual action with a surface of a reinforcing agent, such as carbon black and silica, to enhance the affinity therewith, whereby the rubber composition is improved in strength and workability.

The amount of the end-modified BR mixed is generally from 20 to 80 parts by weight in 100 parts by weight of the rubber component. In the case where the amount is less than 20 parts by weight, the affinity with the reinforcing agent may not be improved, and in the case where the amount exceeds 80 parts by weight, there arise a tendency of decreasing the strength, the durability and the workability.

The BR (C) is BR containing syndiotactic 1,2-polybutadiene crystals, and improves the rigidity of the rubber composition.

The content of the syndiotactic 1,2-polybutadiene component is generally from 5 to 20% by weight, and preferably from 10 to 20% by weight, in the BR. In the case where the content is less than 5% by weight, the rigidity may not be improved, and in the case where it exceeds 20% by weight, the rubber composition may be stiffened, whereby the workability and the durability may be decreased, and the road/tire noise may be increased.

The syndiotactic 1,2-polybutadiene can be obtained by a polymerization method according to JP-B-53-39917, JP-B-54-5436, JP-B-56-18005 and the like.

The BR (B) may be cis-1,4-polybutadiene rubber modified with syndiotactic 1,2-polybutadiene.

The cis-1,4-polybutadiene rubber modified with syndiotactic 1,2-polybutadiene can be obtained by a method according to JP-A-55-31802 and JP-A-5-194658.

The cis-1,4-polybutadiene rubber modified with syndiotactic 1,2-polybutadiene can be obtained as a commercially available product under a trade name, UBEPOL VCR, from Ube Industries, Ltd., and for example, VCR617 may be used.

The rubber composition of the invention contains, in addition to the rubber component, a reinforcing agent, a plasticizer, an additive and a crosslinking agent.

Examples of the reinforcing agent include carbon black, silica, clay and calcium carbonate.

The carbon black is not particularly limited in species thereof and may have a nitrogen absorption specific surface area (N₂SA) of from 25 to 100 m²/g, and examples thereof include carbon black of such grades as HAF, FEF and GPF.

In the case where the N₂SA of the carbon black is less than 25 m²/g, the strength of the rubber composition may be decreased to deteriorate the durability, and in the case where it exceeds 100 m²/g, the hysteresis loss may be increased to increase the rolling resistance and heat generation.

Examples of the silica include one having a BET specific surface area of 250 m²/g or less and having colloidal characteristics.

The silica is not particularly limited as far as it satisfies colloidal characteristics, and examples thereof include wet silica (hydrous silicate), dry silica (anhydrous silicate), calcium silicate and aluminum silicate, and among these, wet silica is preferred since it attains both fracture characteristics and low rolling resistance and is excellent in productivity. Examples of a commercially available product therefor include Nipsil AQ, available from Tosoh Silica Corporation, Tokusil, available from Tokuyama Corporation, and Ultrasil, available from Degussa AG.

The silica may be surface-treated silica having been improved in affinity with a polymer by treating the surface thereof with an amine compound, an organic polymer or the like.

In the case where silica is used, a silane coupling agent is preferably used in an amount of from 2 to 20% by weight, and more preferably from 2 to 15% by weight, based on the amount of the silica. Examples of the silane coupling agent include a sulfur-containing silane coupling agent, such as bis(3-triethoxysilylpropyl)tetrasulfide and bis(3-triethoxysilylpropyl)disulfide, and 3-trimethoxysilylpropylbenzothiazole tetrasulfide.

The total amount of the reinforcing agent mixed is generally from 20 to 80 parts by weight per 100 parts by weight of the rubber component. In the case where the amount of the reinforcing agent is less than 20 parts by weight, the rubber composition may be insufficiently reinforced to decrease the durability of the side wall, and in the case where the amount exceeds 80 parts by weight, the rubber composition may be increased in heat generation and deteriorated in workability.

Examples of the plasticizer, the additive and the crosslinking agent include a process oil of aromatic series, naphthene series or a paraffin series, a vegetable oil, wax, stearic acid, zinc flower, a resin, an antioxidant, a vulcanizing agent, such as sulfur, a vulcanization accelerator and a vulcanization accelerating assistant, and materials that have been known in the technical field of rubber may be used without particular limitation as far as the advantages of the invention are not impaired.

The rubber composition of the invention having the aforementioned constitution has a dynamic elastic modulus (E′) and a loss factor (tan δ), which are measured according to JIS K6394 at an initial strain of 5%, a dynamic strain of 5%, a frequency of 10 Hz and a temperature of 35° C., satisfying relationships, E′≧4 and tan δ/E′≦0.03.

In the case where E′ is less than 4.0, the rubber composition has a low elastic modulus, i.e., large hardness, and when the rubber composition is used as a side wall, the road/tire noise cannot be reduced. In the case where tan δ/E′ exceeds 0.03, the energy loss is increased to fail to reduce the rolling resistance.

The rubber composition containing the aforementioned components may be prepared according to an ordinary method with a rubber kneading machine, such as a Banbury mixer and a kneader.

The pneumatic tire of the invention uses the rubber composition in a side wall thereof, whereby both the road/tire noise upon running and the fuel consumption can be reduced simultaneously. The rubber composition may be applied to the entire side wall or may be applied to a part of the side wall, for example, a tread side or a bead side of a side wall, or an inner layer or an outer layer of a side wall having two-layer structure.

### EXAMPLE

The invention will be described with reference to examples below, but the invention is not construed as being limited to the examples.

100 parts by weight of a rubber component containing from 20 to 80 parts by weight of natural rubber and from 80 to 20 parts by weight of at least one of the following species of butadiene rubber was kneaded with various amounts of carbon black and an aromatic oil by an ordinary method with a Banbury mixer having a capacity of 200 L to prepare rubber compositions of Examples and Comparative Examples. The rubber components and the mixed components used are as follows.

### Rubber Components and Mixed Components

Natural rubber (NR): RSS #3, made in Thailand
Butadiene rubber (BR): BR150B, available from Ube Industries, Ltd.
End-modified butadiene rubber (modified BR): BR1250H, available from Zeon Corporation (with ends modified with tin) Syndiotactic 1,2-polybutadiene-containing butadiene rubber
(VCR): VCR617, available from Ube Industries, Ltd. (cis-1,4-butadiene component: 83%, syndiotactic 1,2-polybutadiene component: 17%)
Carbon black (CB): Seast SO, available from Tokai Carbon Co., Ltd.
Aromatic oil: X-140, available from Japan Energy Corporation

All the rubber compositions each contained, as common components, 3 parts by weight of zinc flower (Zinc Flower, First Class, available from Mitsui Mining And Smelting Co., Ltd.), 2 parts by weight of stearic acid (Lunac S-20, available from Kao Corporation), 2 parts by weight of wax (Sunnoc N, available from Ouchi Shinko Chemical Industrial, Co., Ltd.), 2 parts by weight of an antioxidant (Nocrack 6C, available from Ouchi Shinko Chemical Industrial, Co., Ltd.), 2 parts by weight of sulfur (5% oil-treated powdered sulfur, available from Hosoi Chemical Industry Co., Ltd.) and 1.5 parts by weight of a vulcanization accelerator (Nocceler NS-P, available from Ouchi Shinko Chemical Industrial, Co., Ltd.).

The resulting rubber components were measured for dynamic elastic modulus (E′) and loss factor (tan δ) with Rheospectrometer E4000, available from UBM Co., Ltd. according to JIS K6394 under conditions of an initial strain of 5%, a dynamic strain of 5%, a frequency of 10 Hz and a temperature of 35° C. The measured values of E′ and tan δ are shown in Table 1.

Radial tires of a size 205/65R15 were produced by an ordinary method using the rubber compositions, respectively, in a side wall, and were measured for road/tire noise and rolling resistance by the following methods. Results are shown in Table 1.

### Road/Tire Noise

The tire to be tested was attached to a standard rim with an inner pressure adjusted to 200 kPa, and the same tires were mounted on all the wheels of a passenger automobile of 2,000 cc displacement made in Japan. Two persons were in the automobile on the driving seat (front seat) and the rear right seat, and the automobile was driven at a constant speed of 60 km/h in terms of read of the speedometer. The running noise was measured with a noise level meter using microphones positioned close to the ears on the window side of the persons on the front and rear seats. The results are expressed in terms of a value with respect to 100 for Comparative Example 1. A smaller value is favorable since the road/tire noise is reduced.

### Rolling Resistance

The tire to be tested was attached to a standard rim with an inner pressure adjusted to 200 kPa, and measured for rolling resistance with a uniaxial drum tester for measuring rolling resistance at a load of 400 kg and a speed of 60 km/h. The results are expressed in terms of a value with respect to 100 for Comparative Example 1. A smaller value means a high rolling resistance, which brings about deteriorated fuel consumption.

TABLE 1

| | | | | Compar- | Compar- |
|---|---|---|---|---|---|
| | | | Comparative | ative | ative |
| | Example 1 | Example 2 | Example 1 | Example 2 | Example 3 |
| E′ | 4.5 | 4.1 | 3.1 | 4.2 | 3.0 |
| tanδ/E′ | 0.026 | 0.028 | 0.039 | 0.041 | 0.026 |
| Road/tire | 96 | 97 | 100 | 97 | 101 |
| noise | | | | | |
| (index) | | | | | |
| Rolling | 95 | 96 | 100 | 101 | 95 |
| index | | | | | |
| resistance | | | | | |
| (index) | | | | | |

By using the rubber composition of the invention in a side wall of a pneumatic tire, both the road/tire noise and the rolling resistance can be reduced simultaneously, and thus the rubber composition is suitable particularly to a tire for a passenger automobile demanded to have reduced in-car noise and low fuel consumption.

What is claimed is:

1. A rubber composition comprising
a rubber component containing from 20 to 80 parts by weight of at least one of natural rubber and polyisoprene rubber and from 80 to 20 parts by weight of butadiene rubber,
a reinforcing agent, a plasticizer, an additive and a crosslinking agent, and
having a dynamic elastic modulus (E′) and a loss factor (tan δ), which are measured according to JIS K6394 at an initial strain of 5%, a dynamic strain of 5%, a frequency of 10 Hz and a temperature of 35° C., satisfying relationships, E′≧4 and tan δ/E′≦0.03.

2. The rubber composition as claimed in claim 1, wherein the butadiene rubber contains at least one selected from the group consisting of
(A) a coordination polymer of butadiene with a transition metal compound or a metallocene complex of a transition metal compound as a catalyst,
(B) an anionic polymer of butadiene with a lithium compound as a catalyst, and
(C) butadiene rubber containing syndiotactic 1,2-polybutadiene crystals.

3. The rubber composition as claimed in claim 2, wherein the anionic polymer of butadiene (B) has polymer ends modified with a modifying agent.

4. A pneumatic tire comprising the rubber composition as claimed in one of claims 1 to 3 in a side wall.
